(19) United States
(12) Patent Application Publication
(10) Pub. No.: US 2016/0097955 A1
(43) Pub. Date: Apr. 7, 2016

(54) LIQUID CRYSTAL DISPLAY

(71) Applicant: Samsung Display Co., Ltd., Yongin-City (KR)

(72) Inventors: Ka Eun KIM, Yongin-si (KR); Cheol SHIN, Hwaseong-si (KR); Hak Sun CHANG, Yongin-si (KR); Ki Chul SHIN, Seongnam-si (KR); Se Hyun LEE, Seoul (KR)

(21) Appl. No.: 14/663,329

(22) Filed: Mar. 19, 2015

(30) Foreign Application Priority Data
Oct. 6, 2014 (KR) 10-2014-0134546

(51) Int. Cl. G02F 1/1343

(52) U.S. Cl. CPC G02F 1/134309

(57) ABSTRACT

A liquid crystal display includes a lower electrode, an upper electrode facing the lower electrode, and a liquid crystal layer disposed between the lower electrode and the upper electrode. The lower electrode includes: a center electrode disposed at its center and the center electrode has a polygonal shape including diagonal sides, left and right sides, and upper and lower sides; as first cutout disposed at a center of the center electrode; a plurality of minute branches extending out from the diagonal sides; and a plurality of auxiliary minute branches extending out from the left and right sides. The upper electrode includes a second cutout disposed between the minute branches and the first cutout, and a third cutout connected to the second cutout to form a boundary between a plurality of subregions together with the first cutout, and the left and right sides are inclined at a predetermined angle.

### CROSS-REFERENCE TO RELATED APPLICATION

This application claims priority to and the benefit of Korean Patent Application No. 10-2014-0134546 filed in the Korean Intellectual Property Office on Oct. 6, 2014, the entire contents of which are incorporated herein by reference.

### BACKGROUND

(a) Technical Field

The present disclosure relates to a liquid crystal display, and more particularly, to a liquid crystal display having an increased response speed.

(b) Description of the Related Art

A liquid crystal display device (LCD), which is one of the most widely used flat panel displays at present, typically includes two display panels on which field generating electrodes (such as a pixel electrode and a common electrode) are formed, and a liquid crystal layer interposed between the two display panels. In the liquid crystal display device, an electric field is generated in the liquid crystal layer by applying a voltage to the field generating electrodes. The electric field determines the alignment directions of liquid crystal molecules of the liquid crystal layer, thereby controlling polarization of incident light passing through the liquid crystal layer so as to display images.

Liquid crystal display devices may be provided in different configurations. In a vertically aligned mode liquid crystal display device, the liquid crystal molecules are aligned such that the long axes of the liquid crystal molecules are perpendicular to the upper and lower display panels in the absence of an electric field. The vertically aligned mode liquid crystal display device is widely used because it has a high contrast ratio and a wide viewing angle.

To implement a wide viewing angle in a vertically aligned mode liquid crystal display device, a plurality of domains having different alignment directions of the liquid crystal molecules may be formed in one pixel.

The plurality of domains may be formed by forming cutouts (such as slits and the like) in the field generating electrodes, and aligning the liquid crystal molecules in a vertical direction perpendicular to a fringe field using the edges of the cutouts. The fringe field is formed between the field generating electrodes facing the edges of the cutouts.

The vertically aligned mode liquid crystal display device can be implemented in different forms. In one example, the cutouts (for forming the domains) are formed on both the upper and lower substrates. In another example, the cutouts (for forming the domains) are formed only on the lower substrate and are not formed on the upper substrate. In the above examples, a display area is divided into a plurality of domains by the cutouts, and the liquid crystal molecules in each domain are generally tilted in a same direction.

Recently, an initial alignment method has been proposed to improve response speed of the liquid crystal layer and to implement a wide viewing angle. The method includes pre-tilting the liquid crystal molecules in the absence of an electric field. An alignment layer having various alignment directions may be used to pre-tilt the liquid crystal molecules in various directions. Alternatively, an alignment material may be added to the liquid crystal layer to pre-tilt the liquid crystal molecules and an electric field is then applied to the liquid crystal layer to cure the alignment material. The alignment material can be cured under heat or light (such as ultraviolet rays and the like). After the alignment material is cured, the liquid crystal molecules will be pre-tilted in a predetermined direction. Subsequently, a voltage may be applied to each of the field generating electrodes to generate an electric field in the liquid crystal layer.

However, the alignment material and associated processing (e.g., dispensing and ultraviolet (UV) curing of the alignment material) may require a new process line and incur additional manufacturing costs. Accordingly, the cost of manufacturing the liquid crystal display device may increase, additional manufacturing equipment may be needed, and the manufacturing process may increase in complexity.

The above information disclosed in this Background section is only to enhance understanding of the background of the inventive concept and therefore it may contain information that does not form the prior art that is already known in this country to a person of ordinary skill in the art.

### SUMMARY

The present disclosure provides a liquid crystal display having improved transmittance and response speed, and that can be manufactured at low cost using a simplified manufacturing process without additional equipment.

According to an exemplary embodiment of the inventive concept, a liquid crystal display is provided. The liquid crystal display includes: a lower electrode; an upper electrode facing the lower electrode; and a liquid crystal layer disposed between the lower electrode and the upper electrode, and the liquid crystal layer including a plurality of liquid crystal molecules aligned substantially perpendicular to surfaces of the lower electrode and the upper electrode. The lower electrode includes: a center electrode disposed at its center and the center electrode has a polygonal shape including diagonal sides, left and right sides, and upper and lower sides; a first cutout disposed at a center of the center electrode; a plurality of minute branches extending out from the diagonal sides; and a plurality of auxiliary minute branches extending out from the left and right sides. The upper electrode includes a second cutout disposed between the minute branches and the first cutout, and a third cutout connected to the second cutout to form a boundary between a plurality of subregions together with the first cutout, and the left and right sides are inclined at a predetermined angle.

In some embodiments, the left and right sides may be inclined from a vertical side of the lower electrode at an angle ranging from about 10° to about 20°.

In some embodiments, the minute branches may extend in different directions at different subregions.

In some embodiments, the auxiliary minute branches may extend in different directions at different subregions.

In some embodiments, the first cutout may include a cross-shaped cutout, a central cutout disposed at a center of the cross-shaped cutout, and a central minute cutout extending from the cross-shaped cutout and the central cutout.

In some embodiments, the second cutout may include linear cutouts disposed at the subregions and a vertex disposed on the third cutout.

In some embodiments, the second cutout may be disposed surrounding the first cutout.

According to another exemplary embodiment of the inventive concept, a liquid crystal display is provided. The liquid crystal display includes: a lower electrode; an upper electrode facing the lower electrode; and a liquid crystal layer disposed between the lower electrode and the upper electrode, the liquid crystal layer including a plurality of liquid crystal molecules aligned substantially perpendicular to surfaces of the lower electrode and the upper electrode. The lower electrode includes: a center electrode disposed at its center and the center electrode has a polygonal shape including diagonal sides, left and right sides, and upper and lower sides; a first cutout disposed at a center of the center electrode; and a plurality of minute branches extending out from the diagonal sides. The upper electrode includes a second cutout disposed between the minute branches and the first cutout, and a third cutout connected to the second cutout to form a boundary between a plurality of subregions together with the first cutout, and the diagonal sides are internally bent with respect to a longest minute branch.

In some embodiments, the diagonal sides may be bent at points ranging from about ¼ to about ½ of the upper and lower sides from the center of the center electrode to form vertices.

In some embodiments, the minute branches may extend in different directions at different subregions.

hi some embodiments, the auxiliary minute branches may extend in different directions at different subregions.

In some embodiments, the first cutout may include a cross-shaped cutout, a central cutout disposed at a center of the cross-shaped cutout, and a central minute cutout extending from the cross-shaped cutout and the central cutout.

In some embodiments, the second cutout may include linear cutouts disposed at the subregions and a vertex disposed on the third cutout.

In some embodiments, the second cutout may be disposed surrounding the first cutout.

According to a further exemplary embodiment of the inventive concept, a liquid crystal display is provided. The liquid crystal display includes: a lower electrode; an upper electrode facing the lower electrode; and a liquid crystal layer disposed between the lower electrode and the upper electrode, the liquid crystal layer including a plurality of liquid crystal molecules aligned substantially perpendicular to surfaces of the lower electrode and the upper electrode. The lower electrode includes a center electrode disposed at its center and the center electrode has a polygonal shape including diagonal sides, left and right sides, and upper and lower sides; a first cutout disposed at a center of the center electrode; a plurality of minute branches extending out from the diagonal sides; and a plurality of auxiliary minute branches extending out from the left and right sides. The upper electrode includes a second cutout disposed between the minute branches and the first cutout, and a third cutout connected to the second cutout to form a boundary between a plurality of subregions together with the first cutout, the left and right sides are inclined at a predetermined angle, and the diagonal sides are internally bent with respect to a longest minute branch.

In some embodiments, the left and right sides may be inclined from a vertical side of the lower electrode at an angle ranging from about 10° to about 20°.

In some embodiments, the diagonal sides may be bent at points ranging from about ¼ to about ½ of the upper and lower sides from the center of the center electrode to form vertices.

### BRIEF DESCRIPTION OF THE DRAWINGS

FIG. 1 is a top plan view of a lower electrode of a liquid crystal display according to an exemplary embodiment.

FIG. 2 is a top plan view of an upper electrode of a liquid crystal display according to an exemplary embodiment.

FIG. 3 is a top plan view illustrating the lower electrode of FIG. 1 and the upper electrode of FIG. 2.

FIG. 4 is a layout view illustrating a pixel of a liquid crystal display according to an exemplary embodiment.

FIG. 5 is a cross-sectional view of the liquid crystal display of FIG. 4.

FIGS. 6A and 6B illustrate fringe fields generated by a lower electrode and an upper electrode of a liquid crystal display according to an exemplary embodiment.

FIGS. 7A, 7B, and 7C depict simulation results illustrating the improvement in response speed of a liquid crystal display according to an exemplary embodiment.

FIG. 8 depicts a simulation result illustrating transmittance of a liquid crystal display according to an exemplary embodiment.

FIG. 9 is a top plan view illustrating a unit electrode of a liquid crystal display according to an exemplary embodiment.

FIGS. 10A, 10B, and 10C depict simulation results illustrating the improvement in response speed of a liquid crystal display according to an exemplary embodiment.

FIG. 11 illustrates the improvement in response speed of a liquid crystal display according to an exemplary embodiment.

FIG. 12 is a graph illustrating transmittance of a liquid crystal display according to an exemplary embodiment.

FIG. 13 is a top plan view illustrating a unit electrode of a liquid crystal display according to an exemplary embodiment.

FIGS. 14A and 14B depict simulation results illustrating the improvement in response speed of a liquid crystal display according to an exemplary embodiment.

FIG. 15 is a graph illustrating transmittance of a liquid crystal display according to an exemplary embodiment.

FIG. 16 illustrates a pixel (including two subpixels) of a liquid crystal display according to an exemplary embodiment.

FIG. 17 is an equivalent circuit diagram of a pixel of a liquid crystal display according to an exemplary embodiment.

FIG. 18 is a top plan view of a pixel of a liquid crystal display according to an exemplary embodiment.

FIG. 19 is a cross-sectional view of the liquid crystal display of FIG. 18 taken along line XIX-XIX.

### DETAILED DESCRIPTION

The inventive concept will be described more fully herein with reference to the accompanying drawings, in which exemplary embodiments are shown. As those skilled in the art would realize, the embodiments may be modified in various ways without departing from the spirit or scope of the inventive concept.

In the drawings, the thickness of layers, films, panels, regions, etc., may be exaggerated for clarity. Like reference numerals designate like elements throughout the specification. It will be understood that when an element such as a layer, film, region, or substrate is referred to as being “on” another element, it can be disposed directly on the other element or with one or more intervening elements being present. In contrast, when an element is referred to as being “directly on” another element, there are no intervening elements present.

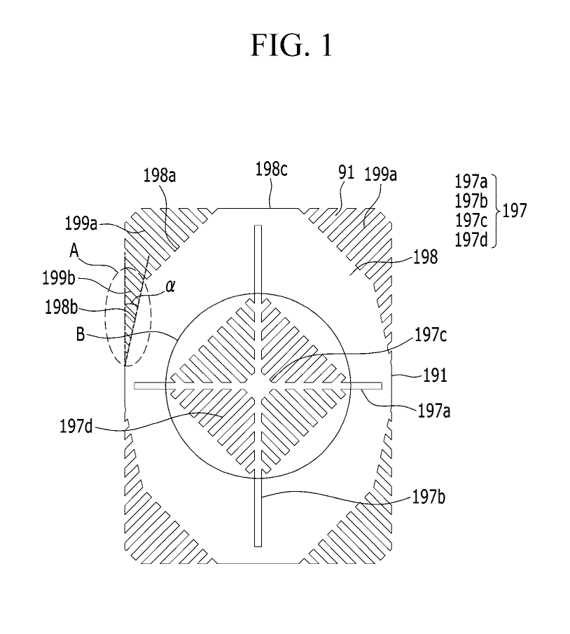

First, a liquid crystal display according to an exemplary embodiment will be described with reference to FIGS. 1, 2, 3, 4, and 5.

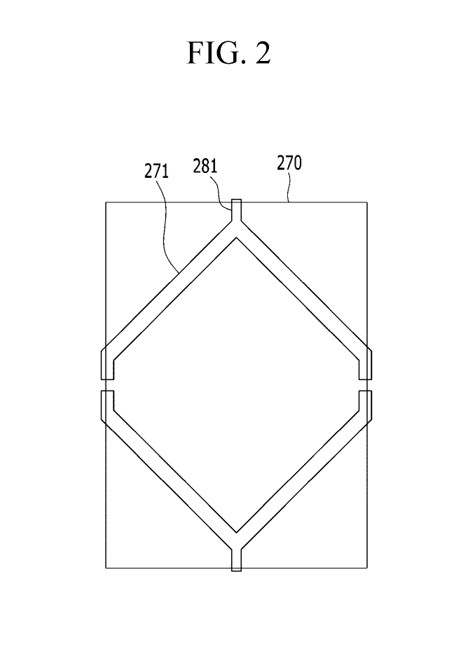

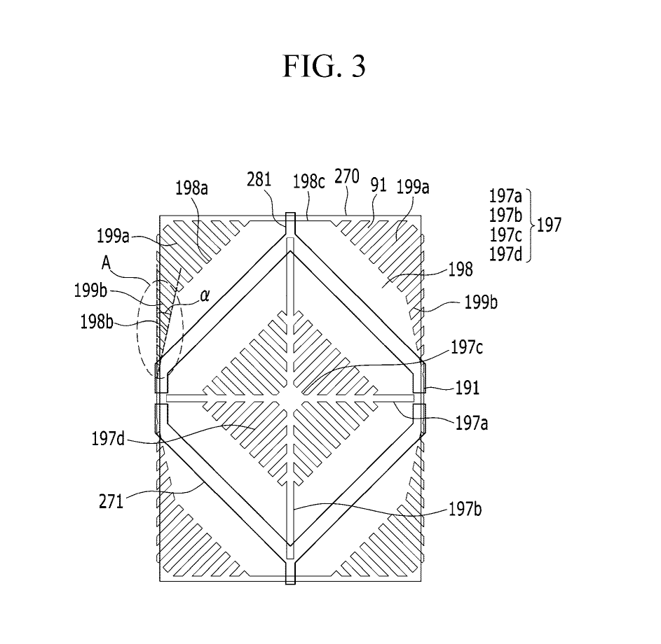

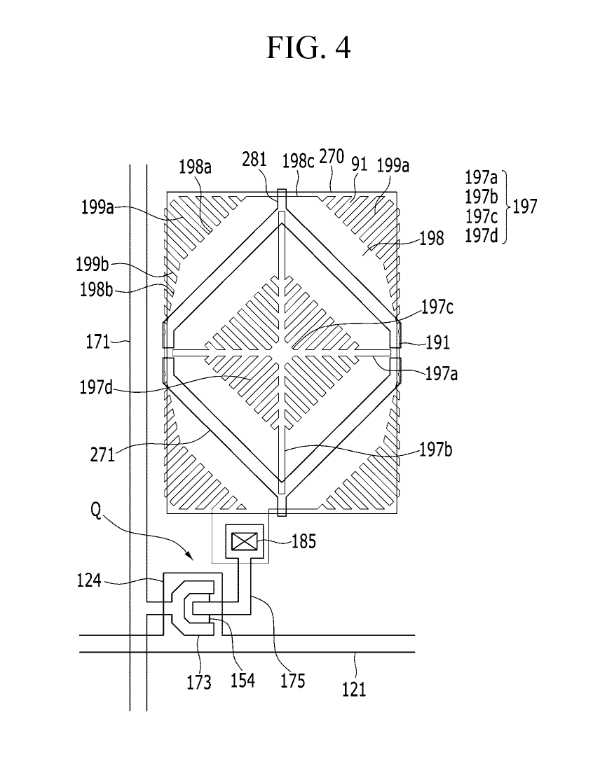

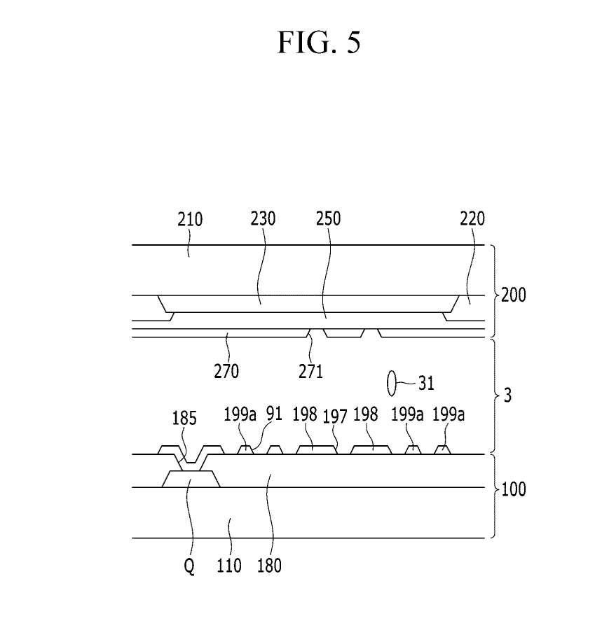

FIG. 1 is a top plan view of a lower electrode of a liquid crystal display according to an exemplary embodiment, FIG. 2 is a top plan view of an upper electrode of a liquid crystal display according to an exemplary embodiment, FIG. 3 is a top plan view illustrating the lower electrode of FIG. 1 and the upper electrode of FIG. 2, FIG. 4 is a layout view illustrating a pixel of a liquid crystal display according to an exemplary embodiment, and FIG. 5 is a cross-sectional view of the liquid crystal display of FIG. 4.

Referring to FIGS. 4 and 5, a liquid crystal display according to an exemplary embodiment includes a lower display panel 100 and an upper display panel 200 facing each other, and a liquid crystal layer 3 interposed between the two display panels 100 and 200.

First, the structure of the lower display panel 100 will be described as follows.

A gate line 121 including a gate electrode 124 is formed on an insulation substrate 110. The gate line 121 transmits a gate signal and extends substantially in a transverse direction.

A gate insulating layer (not shown) is formed on the gate line 121, and a semiconductor 154 is disposed on the gate insulating layer. The semiconductor 154 may be made of hydrogenated amorphous silicon, polysilicon, or an oxide semiconductor.

A data line 171 and a drain electrode 175 are formed on the semiconductor 154 and the gate insulating layer.

The data line 171 transmits data voltages and extends in a substantially longitudinal direction intersecting the gate line 121. The data line 171 includes a source electrode 173 extending toward the gate electrode 124.

The drain electrode 175 is separated from the data line 171 and includes a portion facing the source electrode 173.

The gate electrode 124, the source electrode 173, and the drain electrode 175, together with the semiconductor 154, collectively constitute a thin film transistor (TFT) Q.

A passivation layer 180 is disposed on the thin film transistor Q. The passivation layer 180 has a contact hole 185 exposing the drain electrode 175.

A lower electrode 191 is formed on the passivation layer 180. The lower electrode 191 may be made of a transparent conductive material such as indium tin oxide (ITO) or indium zinc oxide (IZO), or a reflective metal such as aluminum, silver, chromium, or an alloy thereof. The lower electrode 191 may receive the data voltage through the thin film transistor Q which is controlled by the gate signal.

Referring to FIG. 1, the lower electrode 191 disposed at a pixel PX has a quadrangle shape. The lower electrode 191 includes a center electrode 198 disposed at the center of the lower electrode 191, a first cutout 197 disposed at the center of the center electrode 198, and a plurality of minute branches 199 extending out from an edge of the center electrode 198.

The center electrode 198 may be formed as a partially whole plate having a polygonal shape including diagonal sides 198a, left and right sides 198b, and upper and lower sides 198c.

In some embodiments, the diagonal sides 198a may be inclined with respect to the side of the center electrode 198 at an angle of about 45°, and the left and right sides 198b may be inclined with respect to a vertical side A of the lower electrode 191 at an angle α ranging from about 10° to about 20°.

The lower electrode 191 includes a plurality of minute branches 199a and auxiliary minute branches 199b extending from an edge of the center electrode 198.

The minute branches 199a extend out from the diagonal sides 198a of the center electrode 198, and the auxiliary minute branches 199b extend out from the left and right sides of the center electrode 198.

A minute slit 91 (at which an electrode is removed) is disposed between adjacent minute branches 199a and between adjacent auxiliary minute branches 199b. Specifically, a plurality of first minute slits 91 are formed at four corners of the center electrode 198, and the minute branches 199 are formed by the first minute slits 91. Further, a plurality of second minute slits 91 are funned at the left and right sides of the center electrode 198, and the auxiliary minute branches 199b are formed by the second minute slits 91.

Accordingly, the minute branches 199a are disposed at corners of the tour subregions that are divided by the first cutout 197, and the minute branches 199a disposed at each of the subregions extend in different directions. Further, the auxiliary minute branches 199b are disposed at left and right sides of the four subregions, and the auxiliary minute branches 199b disposed at each of the subregions extend in different directions.

Specifically, the minute branches 199a of one subregion disposed at the upper left side among the four subregions extend obliquely from the diagonal side 198a of the center electrode 198 disposed at the upper left side in the upper left direction, the minute branches 199a of one subregion disposed at the upper right side extend obliquely from the diagonal side 198a of the center electrode 198 disposed at the upper right side in the upper right direction, the minute branches 199a of one subregion disposed at the upper left side extend obliquely from the diagonal side 198a of the center electrode 198 disposed at the lower left side in the lower left direction, and the minute branches 199a of one subregion disposed at the lower right side extend obliquely from the diagonal side 198a of the center electrode 198 disposed at the lower right side in the lower right direction.

Further, the auxiliary minute branches 199b of one subregion disposed at the upper left side among the four subregions extend obliquely from the left and right 198b of the center electrode 198 disposed at the upper left side in the upper left direction, the auxiliary minute branches 199b of one subregion disposed at the upper right side extend obliquely from the left and right 198b of the center electrode 198 disposed at the upper right side in the upper right direction, the auxiliary minute branches 199b of one subregion disposed at the upper left side extend obliquely from the left and right 198b of the center electrode 198 disposed at the lower left side in the lower left direction, and the auxiliary minute branches 199b of one subregion disposed at the lower right side extend obliquely from the left and right 198b of the center electrode 198 disposed at the lower right side in the lower right direction.

End portions of at least some of the minute branches 199a are connected to each other through linear connections (not shown). For example, at least one of the end portions of the minute branches 199a disposed at an upper end, a lower end, a left end, and a right end of the lower electrode 191 may be connected to each other to form an external frame of the lower electrode 191.

The first cutout 197 is disposed at the center of the center electrode 198.

The first cutout 197 includes cross-shaped cutouts 197a and 197b, a central cutout 197c disposed at the center of the cross-shaped cutouts 197a and 197b, and central minute cutouts 197d extending from the cross-shaped cutouts 197a and 197b and the central cutout 197c.

The cross-shaped cutouts 197a and 197b include a horizontal cutout 197a that extends substantially parallel to the gate line 121 and a vertical cutout 197b that extends substantially parallel to the data line 171.

In the above embodiment, the lower electrode 191 of a pixel PX may be divided into four subregions by the cross-shaped cutouts 197a and 197b and a third cutout 281, as described later in the specification.

The central cutout 197c may be formed in a region at which the horizontal cutout 197a and the vertical cutout 197b cross each other. The central cutout 197c may have a polygonal shape (e.g., a rhombic shape) including four linear sides positioned at the four subregions. A vertex of the central cutout 197c is connected to the horizontal cutout 197a and the vertical cutout 197b.

The central minute cutouts 197d may be formed having a rhombic shape B while extending from the cross-shaped cutouts 197a and 197b and the central cutout 197c.

Accordingly, the central minute cutout 197d extend in different directions at different subregions. Specifically, the central minute cutouts 197d of one subregion disposed at an upper left side among the four subregions of the lower electrode 191 extend obliquely from the cross-shaped cutouts 197a and 197b and the central cutout 197c in an upper left direction, the central minute cutouts 197d of one subregion disposed at an upper right side extend obliquely from the cross-shaped cutouts 197a and 197b and the central cutout 197c in an upper right direction, the central minute cutouts 197d of one subregion disposed at a lower left side extend obliquely from the cross-shaped cutouts 197a and 197b and the central cutout 197c in a lower left direction, and the central minute cutouts 197d of one subregion disposed at a lower right side extend obliquely from the cross-shaped cutouts 197a and 197b and the central cutout 197c in a lower right direction.

Next, the upper display panel 200 will be described.

Referring back to FIG. 5, a color filter 230 and a light blocking member 220 may be disposed on an insulation substrate 210. The light blocking member 220 is a black matrix and prevents light leakage between the upper display panel 200 and the lower electrode 191. The color filter 230 may display any one of primary colors, such as the three primary colors red, green, and blue.

In some alternative embodiments, at least one of the light blocking member 220 and the color filter 230 may be disposed on the lower display panel 100.

An overcoat 250 is disposed on the color filter 230 and the light blocking member 220, and an upper electrode 270 is disposed on the overcoat 250. The upper electrode 270 may be made of a transparent conductor or metal (such as indium tin oxide (ITO) or indium zinc oxide (IZO)). The upper electrode 270 may receive a common voltage Vcom.

Referring to FIG. 2, the upper electrode 270 disposed at a pixel PX includes a second cutout 271 having a substantially rhombic shape and a third cutout 281 connected to the second cutout 271.

The second cutout 271 has a rhombic shape including four linear cutouts that are respectively disposed at the four subregions. The linear cutouts are respectively disposed at the four subregions, a first linear cutout of the subregion disposed at the upper left side meets a second linear cutout of the subregion disposed at the upper right side to form an upper vertex, and a third linear cutout of the subregion disposed at the lower left side meets a fourth linear cutout of the subregion disposed at the lower right side to form a lower vertex.

The third cutout 281 is connected to vertices of the four linear cutouts and extends in an external direction. Specifically, the third cutout 281 extends substantially in the same direction as the vertical cutout 197b.

Referring to FIGS. 1, 2, and 3, the second cutout 271 of the upper electrode 270 is disposed between the minute branches 199a of the lower electrode 191 and the first cutout 197 of the lower electrode 191 while overlapping with the center electrode 198 of the lower electrode 191. In other words, the second cutout 271 is formed having a rhombic shape that is larger than that of the central cutout 197c of the lower electrode 191, so as to surround the first cutout 197 of the lower electrode 191.

The vertical cutout 197b of the lower electrode 191 and the second cutout 271 of the upper electrode 270 are formed partially overlapping each other. Specifically, an end portion of the vertical cutout 197b of the lower electrode 191 is formed overlapping the vertex of the second cutout 271 of the upper electrode 270. In the above embodiment, the vertical cutout 197b of the lower electrode 191 and the third cutout 281 of the upper electrode 270 extend substantially in the same direction.

A unit electrode comprising the lower electrode 191 and the upper electrode 270 may be divided into a plurality of subregions by the cross-shaped cutouts 197a and 197b of the lower electrode 191 and the third cutout 281 of the upper electrode 270.

Referring back to FIG. 5, the liquid crystal layer 3 disposed between the display panels 100 and 200 includes liquid crystal molecules 31 having negative dielectric anisotropy. The liquid crystal molecules 31 may be arranged such that a longitudinal axis of the liquid crystal molecules 31 is perpendicular to the surfaces of the two display panels 100 and 200 in the absence of an electric field. The alignment of the liquid crystal molecules 31 of a pixel PX may be divided according to the position of the sub-region, and need not be pre-tilted in the length direction of the minute branch 199 with respect to the surface of the display panels 100 and 200. Accordingly, it is not necessary to include a cured alignment material in the liquid crystal layer 3 to provide a pre-tilt to the liquid crystal molecules 31, unlike in the conventional art.

As such, the liquid crystal display according to the present embodiment does not require an additional process (such as a hardening process of an alignment material) for achieving the pre-tilt in the liquid crystal molecules. Accordingly, the manufacturing cost of the liquid crystal display can be reduced and the manufacturing process can be simplified.

A polarizer (not shown) is disposed on an external surface of at least one of the two display panels 100 and 200. In some embodiments, the polarization axes of two polarizers may be perpendicular to each other, and one of the polarization axes may be substantially parallel to the gate line 121.

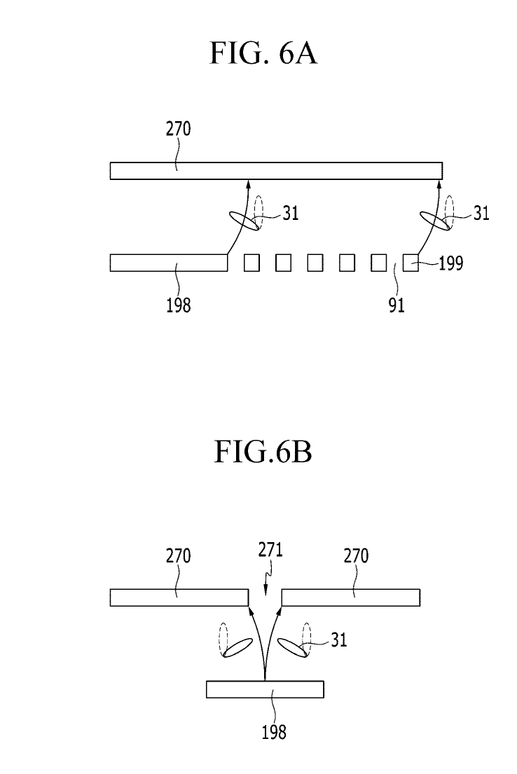

Next, a method of driving the liquid crystal display according to an exemplary embodiment of will be described with reference to FIGS. 6A and 6B, as well as FIGS. 1 through 5.

FIGS. 6A and 6B illustrate fringe fields generated by a lower electrode and an upper electrode of a liquid crystal display according to an exemplary embodiment.

When a gate-on voltage Von is applied to the gate electrode 124 of the thin film transistor Q to turn on the thin film transistor Q the data voltage is also applied to the lower electrode 191. An electric field is generated in the liquid crystal layer 3 by applying the data voltage to the lower electrode 191 and the common voltage Vcom to the upper electrode 270.

The electric field includes a vertical component having a direction substantially perpendicular to the surfaces of the display panels 100 and 200, and the vertical component of the electric field causes the liquid crystal molecules 31 to incline in a direction substantially parallel to the surfaces of the display panels 100 and 200.

Referring to FIGS. 6A and 6B, a fringe field is generated by the edge of the minute branches 199 of the lower electrode 191, the center electrode 198 of the lower electrode 191, and the second cutout 271 of the upper electrode 270. Specifically, referring to FIG. 6A, the fringe field causes the liquid crystal molecules 31 disposed near the edge of the minute branches 199 and the edge of the center electrode 198 to incline toward the inside of the center electrode 198 and the minute branches 199 of the lower electrode 191. Referring to FIG. 6B, the fringe field causes the liquid crystal molecules 31 positioned near the edge of the second cutout 271 of the upper electrode 270 to incline toward the inside of the second cutout 271.

As a result, the liquid crystal molecules 31 are mostly inclined toward the center portion of the second cutout 271 in a direction substantially parallel to the minute branches 199. Accordingly, the inclination directions (referred to as an arrangement direction) of the liquid crystal molecules 31 are different with respect to the second cutout 271 of the upper electrode 270.

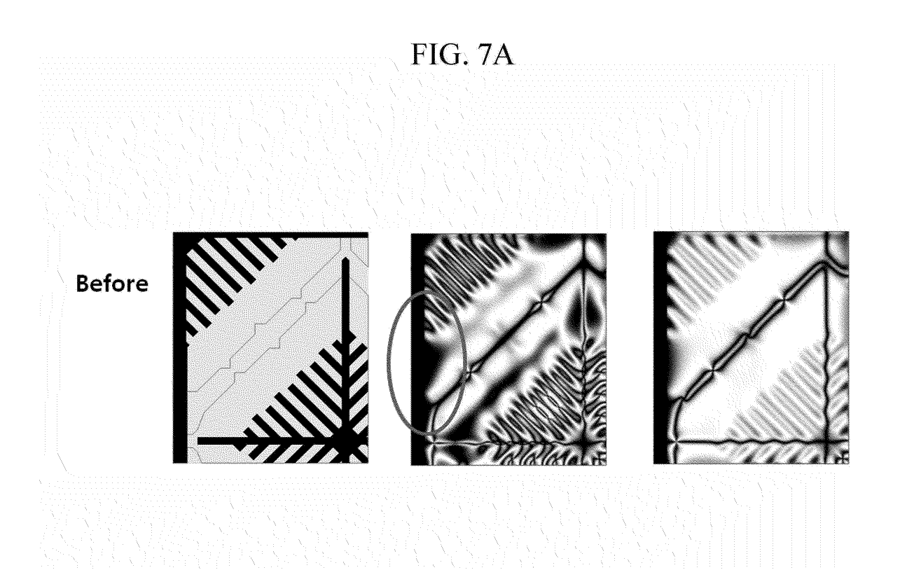

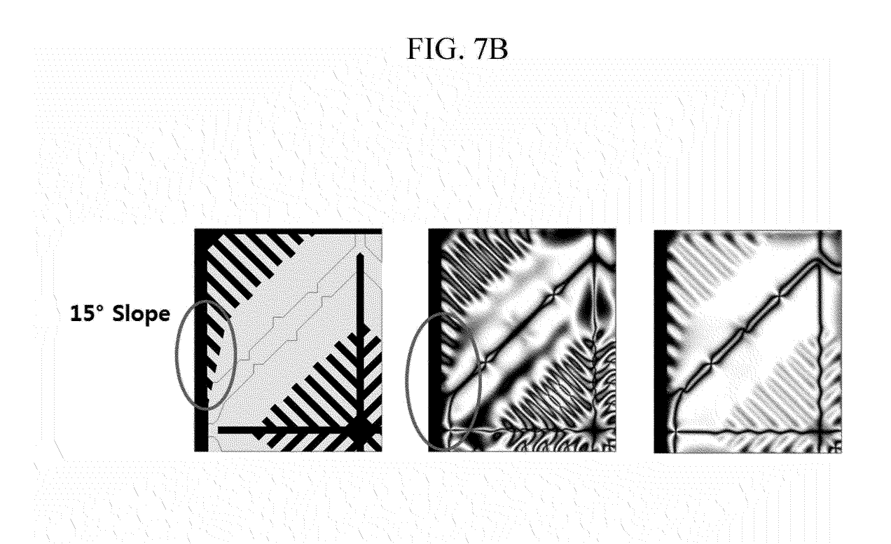

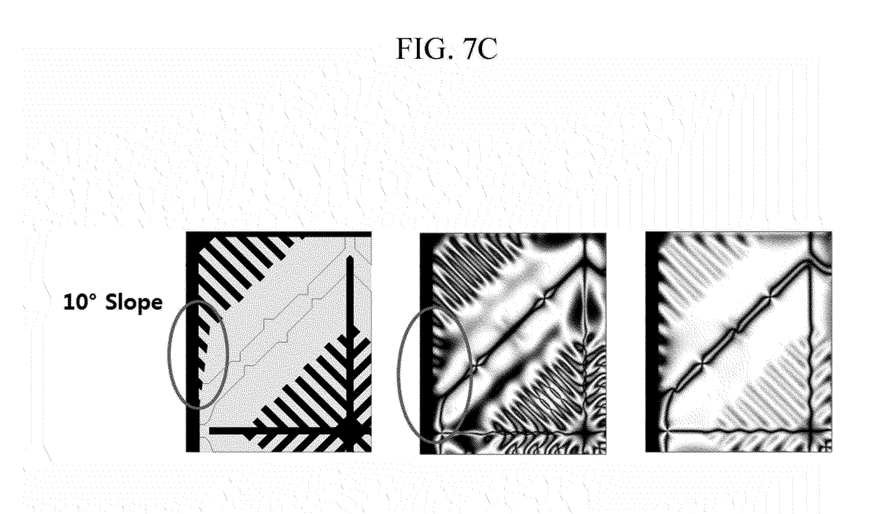

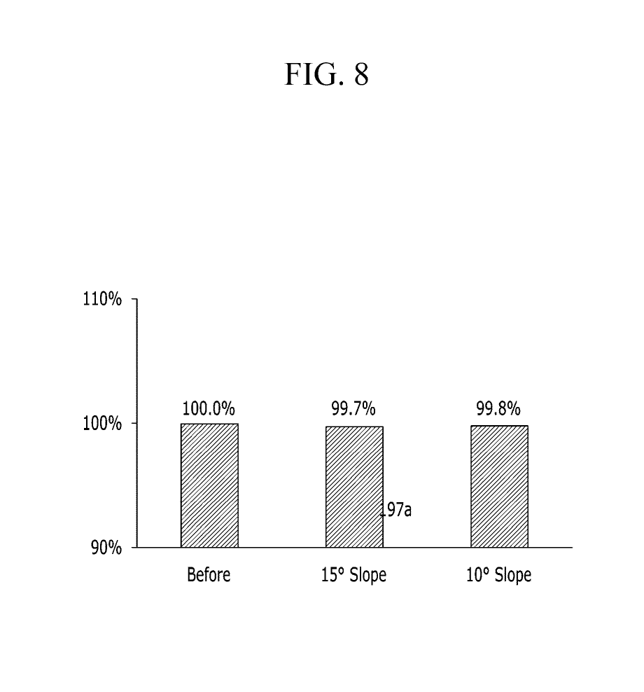

Next, a liquid crystal display having an improved response speed according to an exemplary embodiment will be described with reference to FIGS. 7A, 7B, 7C, and 8, as well as FIGS. 1 through 5.

FIGS. 7A, 7B, and 7C depict simulation results illustrating the improvement in response speed of a liquid crystal display according to an exemplary embodiment. Specifically, FIG. 7A shows simulation images of a lower electrode 191 in which the auxiliary minute branches 199b are not included; FIG. 7B shows simulation images of a lower electrode including the auxiliary minute branches 199b extending from the left and right sides 198b of the center electrode 198 which is inclined from the vertical side A of the lower electrode 191 at an angle of 15°; and FIG. 7C shows simulation images of a lower electrode including the auxiliary minute branches 199b extending from the left and right sides 198b of the center electrode 198 which is inclined from the vertical side A of the lower electrode 191 at an angle of 10°. FIG. 8 depicts a simulation result illustrating transmittance of a liquid crystal display according to an exemplary embodiment.

Referring to FIGS. 7 and 8, a lateral field generated from the left and right sides 198b of the center electrode 198 interrupts movement of liquid crystal molecules 31, thereby decreasing the response speed in the lower electrode 191 in which the auxiliary minute branches 199b are not included.

However, in the liquid crystal display according to the exemplary embodiment, the effect of the lateral field may be reduced to improve the response speed by including the auxiliary minute branches 199b in the lower electrode 191. In this case, the auxiliary minute branches 199b may extend from the left and right sides 198b of the center electrode 198, and the left and right sides of the center electrode 198 may be inclined from the vertical side A of the lower electrode 191 at an angle ranging from about 10° to about 20°. Comparing the liquid crystal display shown in FIGS. 7B and 7C with the liquid crystal display shown in FIG. 7A, it is seen that the lateral field is reduced in the liquid crystal display including the auxiliary minute branches 199b compared to the liquid crystal display without the auxiliary minute branches 199b.

Further, referring to FIG. 8, the transmittance is slightly reduced by about 0.02% to 0.03% in the liquid crystal display including the auxiliary minute branches 199b compared to the liquid crystal display without the auxiliary minute branches 199b, in order to accomplish the same level of transmittance.

In other words, the response speed of the liquid crystal display including the auxiliary minute branches 199b according to the exemplary embodiment can be improved by reducing the lateral field while maintaining the transmittance.

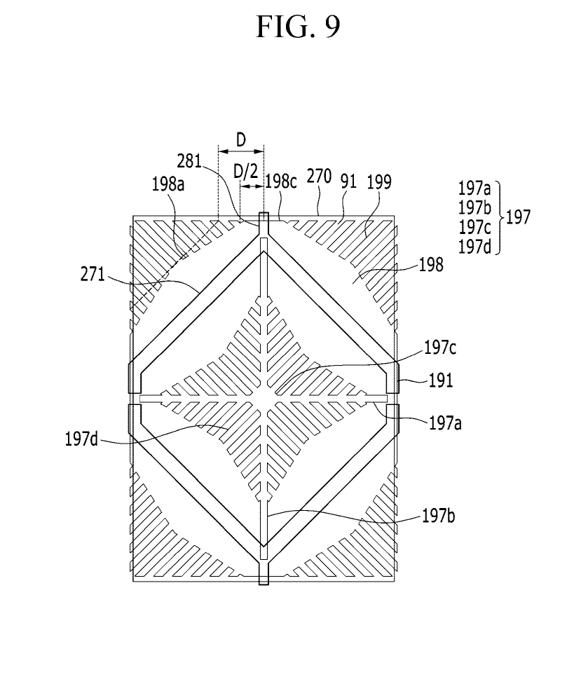

Next, a liquid crystal display having an improved response speed according to an exemplary embodiment will be described with reference to FIGS. 9, 10A, 10B, 10C, 11, and 12. Like elements are designated by the same reference numerals, and thus a repeat description of those elements will be omitted.

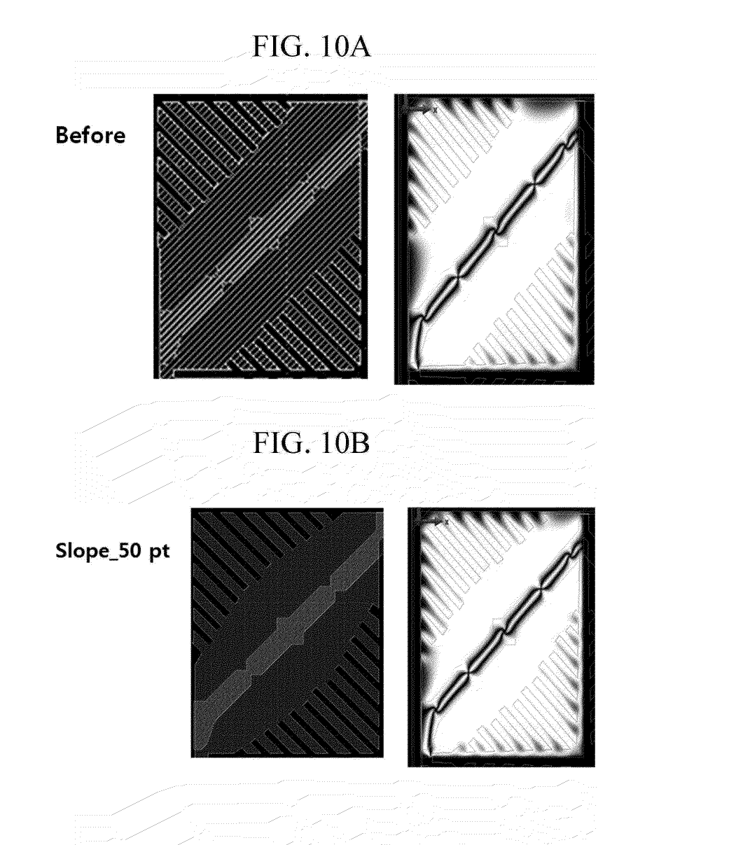

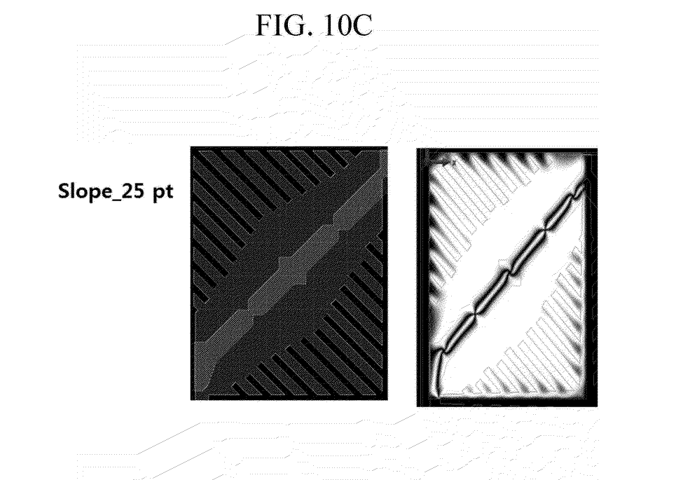

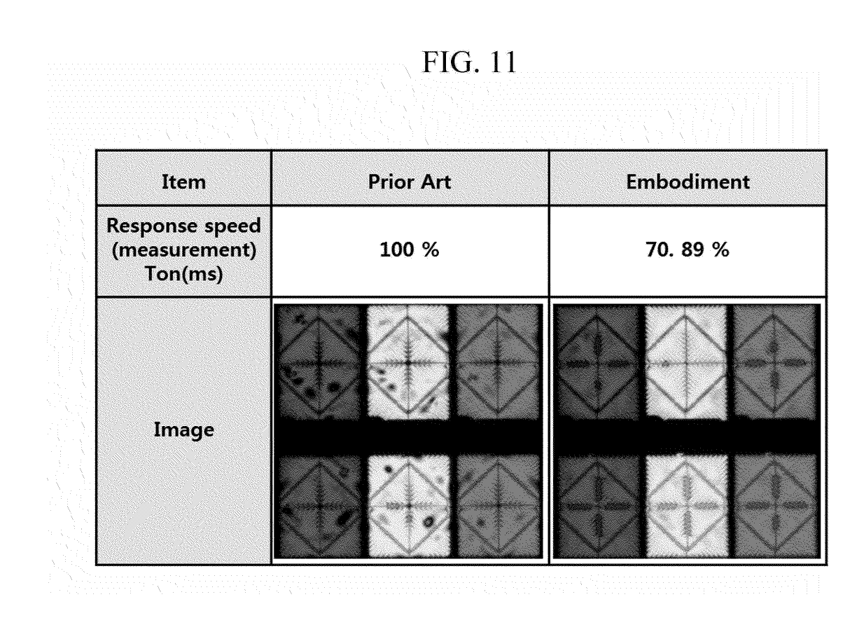

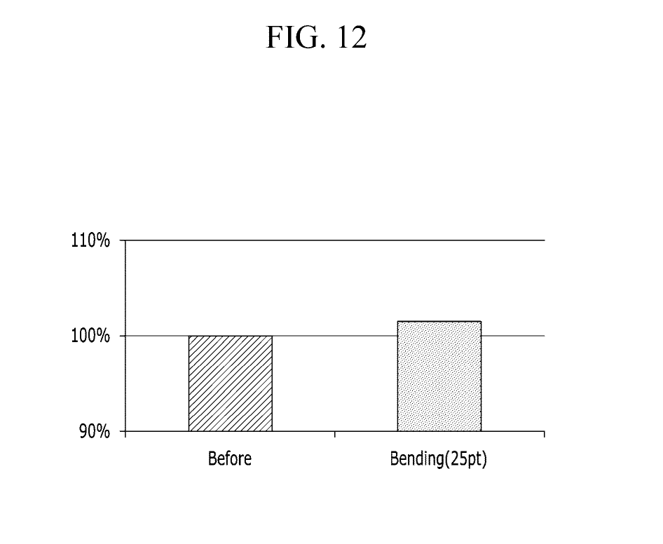

FIG. 9 is a top plan view illustrating a unit electrode of a liquid crystal display according to an exemplary embodiment. FIGS. 10A, 10B, and 10C depict simulation results illustrating the improvement in response speed of a liquid crystal display according to an exemplary embodiment. Specifically, FIG. 10A shows simulation images of a lower electrode in which the diagonal sides 198a of the center electrode 198 are linearly formed; FIG. 10B shows simulation images of a lower electrode in which the diagonal sides 198a of the center electrode 198 are bent at a ½ (midway) point of the upper and lower side 198c from the center thereof; and FIG. 10C shows simulation images of a lower electrode in which the diagonal sides 198a of the center electrode 198 are bent at a ¼ (quarter) point of the upper and lower side 198c from the center thereof. FIG. 11 illustrates the improvement in response speed of a liquid crystal display according to an exemplary embodiment, and FIG. 12 is a graph illustrating transmittance of a liquid crystal display according to an exemplary embodiment.

The lower electrode 191 in FIG. 9 is similar to the lower electrode 191 in the previously-described embodiments except for the following differences. In the embodiment of FIG. 9, the auxiliary minute branches 199b are not included in the lower electrode 191, and the diagonal sides 198a of the center electrode 198 are internally bent with respect to the longest minute branch 199a.

As an area of the center electrode 198 is reduced, the liquid crystal molecules 31 may be more quickly aligned, thereby mitigating the delay in the response speed. In this case, if the area of the center electrode 198 is reduced by adjusting a diagonal linear side without internal bending, the length of the minute branches 199a is increased. Accordingly, it is difficult to entirely mitigate the delay in the response speed. However, in the exemplary liquid crystal display of FIG. 9, although the area of the center electrode 198 is reduced, the length of the minute branches 199a is not increased because the diagonal sides 198a of the center electrode 198 are internally bent. Specifically, the diagonal sides 198a of the center electrode 198 may be internally bent to form vertices at points ranging front about ¼ to ½ of the upper and lower sides 198c from the center thereof.

Referring to FIGS. 10A, 10B, and 11, it is seen that the response speed of the exemplary liquid crystal display in which the diagonal sides 198a of the center electrode 198 are internally bent at ¼ or ½ points of the upper and lower sides 198c from the center is improved by 70.89% compared to another liquid crystal display in which the diagonal sides 198a of the center electrode 198 are merely linearly formed.

Further, referring to FIG. 12, it is seen that the transmittance of the exemplary liquid crystal display is improved by about 1.5% by internally bending the diagonal sides 198a of the center electrode 198 compared to another liquid crystal display without internal bending.

Accordingly, the response speed and the transmittance of the exemplary liquid crystal display is improved by internally bending the diagonal sides 198a of the center electrode 198 to reduce the area of the center electrode 198.

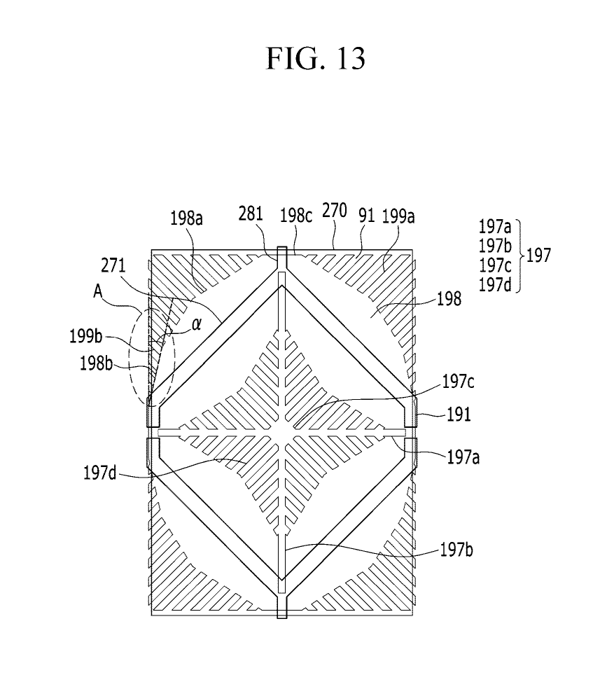

Next, a liquid crystal display having an improved response speed according to an exemplary embodiment will be described with reference to FIGS. 13, 14A, 14B, and 15. Like elements are designated by the same reference numerals, and thus a repeat description of those elements will be omitted.

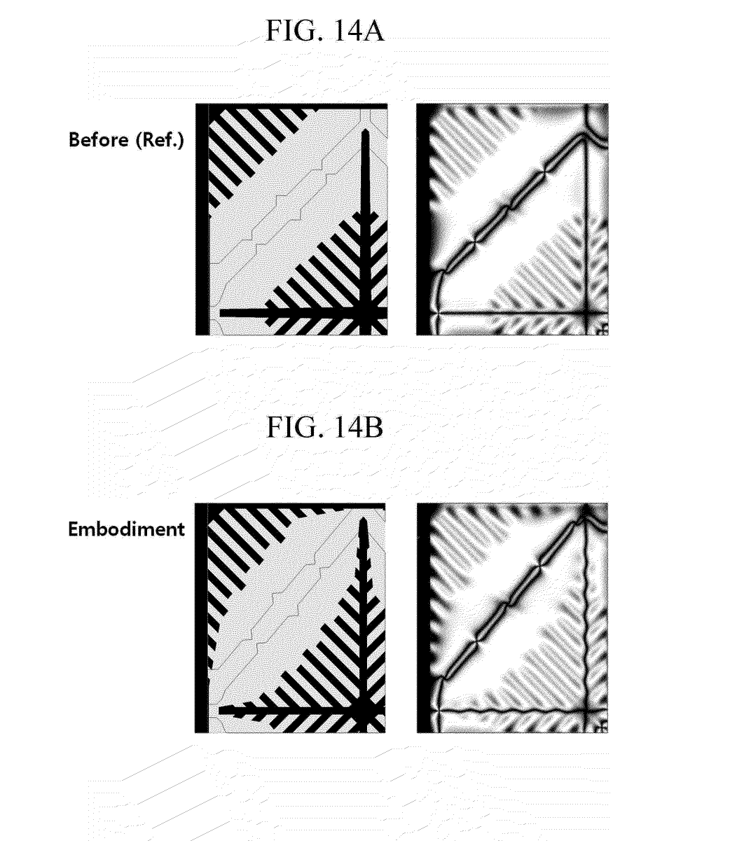

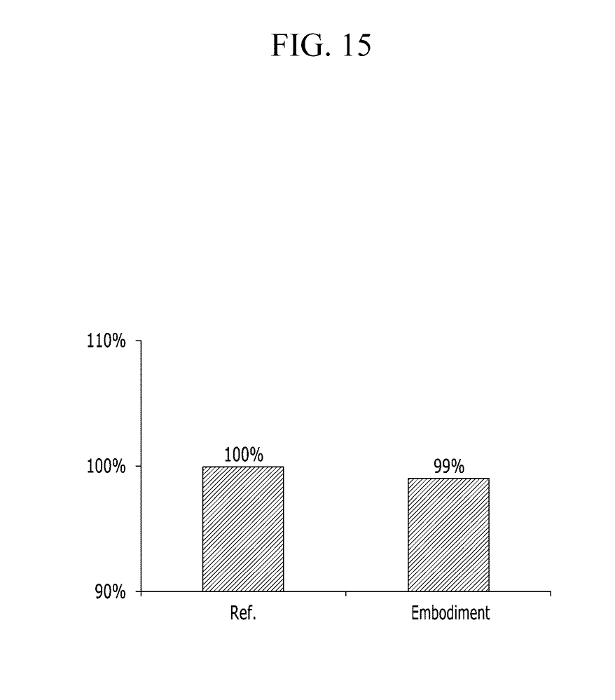

FIG. 13 is a top plan view illustrating a unit electrode of a liquid crystal display according to an exemplary embodiment. FIGS. 14A and 1413 depict simulation results illustrating the improvement in response speed of a liquid crystal display according to an exemplary embodiment. Specifically, FIG. 14A shows simulation images of a lower electrode in which the auxiliary minute branches 199b are not included and the diagonal sides 198a of the center electrode 198 are linearly formed: and FIG. 14B shows simulation images of a lower electrode in which the auxiliary minute branches 199b are included and the diagonal sides 198a of the center electrode 198 are internally bent. FIG. 15 is a graph illustrating transmittance of as liquid crystal display according to an exemplary embodiment.

The lower electrode 191 in the embodiment of FIG. 13 is similar to the lower electrode 191 in the previously-described embodiments except for the following difference. Specifically, the auxiliary minute branches 199b are included in the embodiment of FIG. 13, whereas the diagonal sides 198a of the center electrode 198 in the embodiment of FIG. 9 are internally bent.

Referring to FIGS. 14 and 15, as described above, the lower electrode 191 of the exemplary liquid crystal display includes the auxiliary minute branches 199b, and has improved response speed and transmittance when the diagonal sides 198a of the center electrode 198 are internally bent.

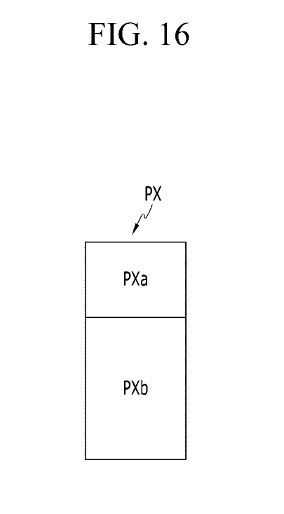

FIG. 16 illustrates a pixel (including two subpixels) of a liquid crystal display according to an exemplary embodiment.

Referring to FIG. 16, a pixel PX of a liquid crystal display according to an exemplary embodiment may include a first sub-pixel PXa and a second sub-pixel PXb. The first sub-pixel PXa and the second sub-pixel PXb may also display images according to different gamma curves and display images depending on the same gamma curve, for one input image signal. That is, the first sub-pixel PXa and the second sub-pixel PXb of one pixel PX may display images having different luminance to improve side visibility with one input image signal. In some embodiments, the areas of the first sub-pixel PXa and the second sub-pixel PXb may be the same as each other. In other embodiments, the areas of the first sub-pixel PXa and the second sub-pixel PXb may be different from each other.

Accordingly, the pixel PX including the first sub-pixel PXa and the second sub-pixel PXb may have various circuit structures and dispositions to display images having different luminance.

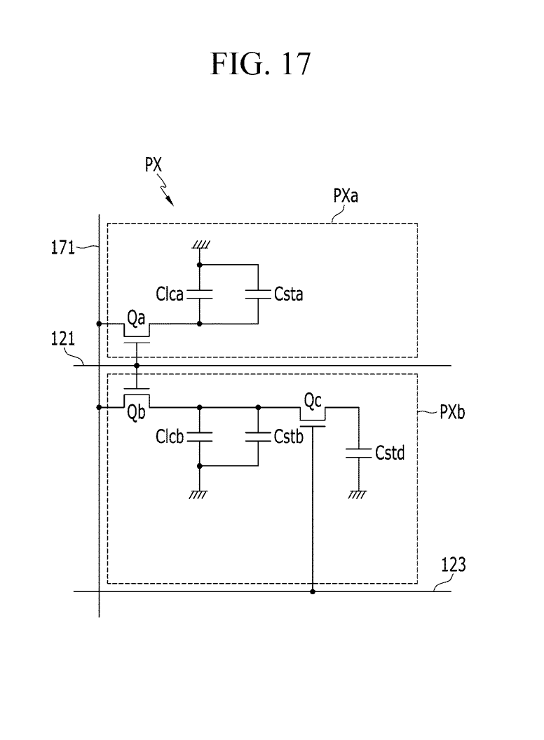

FIG. 17 is an equivalent circuit diagram of a pixel of a liquid crystal display according to an exemplary embodiment.

Referring to FIG. 17, the liquid crystal display includes signal lines including as gate line 121, a step-down gate line 123, and a data line 171, and a pixel PX connected to the signal lines.

Each pixel includes first and second subpixels PXa and PXb. The first subpixel PXa includes a first switching element Qa, a first liquid crystal capacitor Clca, and a first storage capacitor Csta. The second subpixel PXb includes second and third switching elements Qb and Qc, a second liquid crystal capacitor Clcb, a second storage capacitor Cstb, and a step-down capacitor Cstd.

The first and second switching elements Qa and Qb are respectively connected to the gate line 121 and the data line 171, and the third switching element Qc is connected to the step-down gate line 123.

The switching elements Qa and Qb are three-terminal elements such as thin film transistors. Control terminals of the switching elements Qa and Qb are connected to the gate lines 121, input terminals of the switching elements Qa and Qb are connected to the data lines 171, and output terminals of the switching elements Qa and Qb are respectively connected to the first and second liquid crystal capacitors Clca and Clcb and the first and second storage capacitors Csta and Cstb.

The third switching element Qc is also a three-terminal element such as a thin film transistor. A control terminal of the third switching element Qc is connected to the step-down gate line 123, an input terminal of the third switching element Qc is connected to the second liquid crystal capacitor Clcb, and an output terminal of the third switching element Qc is connected to the step-down capacitor Cstd.

The step-down capacitor Cstd is connected to the output terminal of the third switching element Qc and a common voltage.

Next, the operation of the pixel PX will be described. First, a gate-on voltage Von is applied to the gate line 121, and the first and second switching elements Qa and Qb connected to the gate line 121 are turned on. Accordingly, the data voltage of the data line 171 is applied to the first and second liquid crystal capacitors Clca and Clcb through the turned-on first and second switching elements Qa and Qb such that the first and second liquid crystal capacitors Clca and Clcb are charged with a voltage difference between the data voltage Vd and the common voltage Vcom. In this instance, a gate-off voltage Voff is applied to the step-down gate line 123.

Next, when the gate-off voltage Voff is applied to the gate line 121 and the gate-on voltage Von is applied to the step-down gate line 123, the first and second switching elements Qa and Qb are turned off, and the third switching element Qc is turned on. As a result, a charging voltage of the second liquid crystal capacitor Clcb connected with the output terminal of the second thin film transistor Qb is reduced. Accordingly, when the liquid crystal display is driven by frame inversion, the charging voltage of the second liquid crystal capacitor Clcb may be lower than a charging voltage of the first liquid crystal capacitor Clca. Accordingly, it is possible to improve visibility of the livid crystal display by differentiating the charge voltages of the first and second liquid crystal capacitors Clca and Clcb.

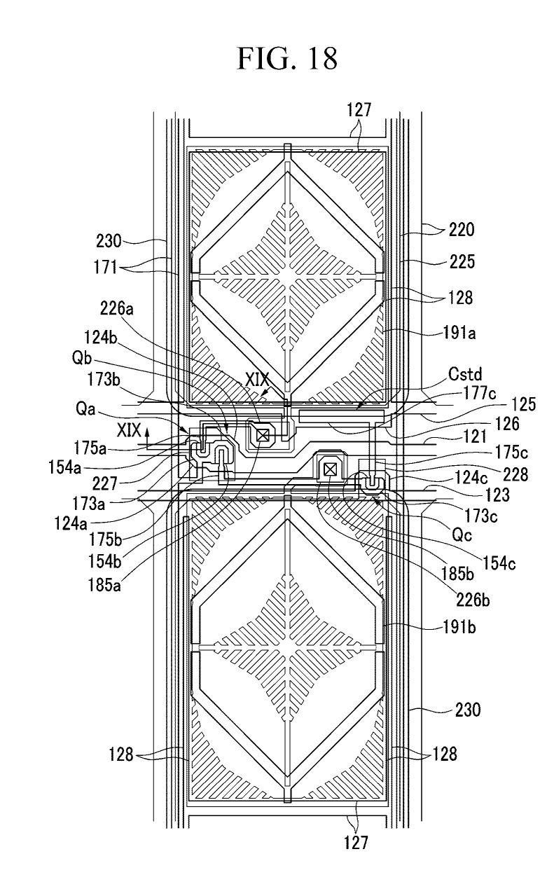

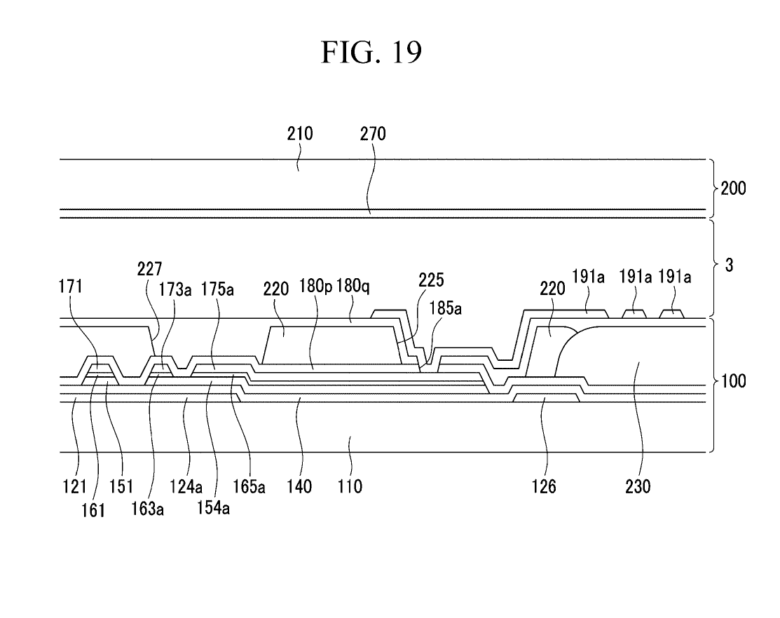

Now, referring to FIGS. 18 and 19, a liquid crystal display having the circuit structure illustrated in FIG. 15 according to an exemplary embodiment will be described. Like elements are designated by the same reference numerals, and thus a repeat description of those elements will be omitted.

FIG. 18 is a top plan view of a pixel of a liquid crystal display according to an exemplary embodiment. FIG. 19 is a cross-sectional view of the liquid crystal display of FIG. 18 taken along line XIX-XIX.

The liquid crystal display according to the exemplary embodiment includes lower and upper display panels 100 and 200 facing each other, and a liquid crystal layer 3 interposed between the two display panels 100 and 200.

Since the liquid crystal layer 3 is the same as the liquid crystal layer previously described above with reference to FIGS. 1 through 5, a detailed description of the liquid crystal layer will be omitted.

First, the lower display panel 100 will be described. A plurality of gate conductors including the gate line 121, the step-down gate line 123, and a storage electrode line 125 are formed on an insulation substrate 110. The gate line 121 and the step-down gate line 123 extend in a substantially horizontal direction, and transmit a gate signal. The gate line 121 may include a first gate electrode 124a and a second gate electrode 124b, and the step-down gate line 123 may include a third gate electrode 124c. The first and second gate electrodes 124a and 124b are connected to each other. The storage electrode line 125 may extend in the substantially horizontal direction, and transmits a predetermined voltage such as the common voltage Vcom. The storage electrode line 125 may include a storage extension portion 126, a pair of vertical portions 128 extending substantially upwards such that the vertical portions 128 are perpendicular to the gate line 121, and a horizontal portion 127 connecting the pair of vertical portions 128. However, it should be noted that the structure of the storage electrode line 125 is not limited to the above-described configuration, and may be modified in various ways.

A gate insulating layer 140 is disposed on the gate conductor, and a linear semiconductor 151 is disposed on the gate insulating layer 140. The linear semiconductor 151 may extend in a substantially vertical direction. The linear semiconductor 151 includes first and second semiconductors 154a and 154b extending toward the first and second gate electrodes 124a and 124b and connected to each other, and a third semiconductor 154c connected to the second semiconductor 154b.

An ohmic contact 161 is formed on the linear semiconductor 151, ohmic contacts 163a and 165a are formed on the first semiconductor 154a, and ohmic contacts are also formed on the second semiconductor 154b and the third semiconductor 154c, respectively. However, in some particular embodiments, the ohmic contacts 161 and 165a may be omitted.

A data conductor is formed on the ohmic contacts 161 and 165a. The data conductor includes the data line 171, a first drain electrode 175a, a second drain electrode 175b, and a third drain electrode 175c. The data line 171 may include a first source electrode 173a and a second source electrode 173b extending toward the first gate electrode 124a and the second gate electrode 124b, respectively. Rod-shaped end portions of the first drain electrode 175a and the second drain electrode 175b are partially surrounded by the first source electrode 173a and the second source electrode 173b. A wide end of the second drain electrode 175b is extended to form a third source electrode 173c bent in a U-shape. A wide end portion 177c of the third drain electrode 175c overlaps the storage extension portion 126 to form the step-down capacitor Cstd, and a rod-shaped end portion of the third drain electrode 175c is partially surrounded by the third source electrode 173c.

The first, second, and third gate electrodes 124a/124b/124c, the first, second, and third source electrodes 173a/173b/173c, and the first, second, and third drain electrodes 175a/175b/175c, together with the first, second, and third semiconductors 154a/154b/154c, collectively form the first, second, and third switching elements Qa/Qb/Qc, respectively.

A lower passivation layer 180p may be disposed on the data conductors 171, 175a, 175b, and 175c and exposed portions of the semiconductors 154a, 154b, and 154c. A color filter 230 and a light blocking member 220 may be disposed on the lower passivation layer 180p. The light blocking member 220 may include an opening 227 disposed on the first and second switching elements Qa and Qb, an opening 226a disposed on the wide end portion of the first drain electrode 175a, an opening 226b disposed on the wide end portion of the second drain electrode 175b, and an opening 228 disposed on the third switching element Qc. In some alternative embodiments, at least one of the color filter 230 and the light blocking member 220 may be disposed on the upper display panel 200.

An upper passivation layer 180q is disposed on the color filter 230 and the light blocking member 220. A plurality of contact holes 185a and 185b respectively exposing the first and second drain electrodes 175a and 175b are formed in the lower passivation layer 180p and the upper passivation layer 180q.

The lower panel electrode is disposed on the upper passivation layer 180q. The lower panel electrode includes a first electrode 191a and a second electrode 191b. Each of the first electrode 191a and the second electrode 191b may have the same structure as the lower electrode 191 shown in the embodiments of FIG. 3, 9, or 13.

To improve the response speed and the transmittance, the lower electrode 191 may include the auxiliary minute branches 199b. Also, the display panel may include the lower electrode 191 in which the diagonal sides 198a of the center electrode 198 are internally bent. FIG. 18 illustrates an example of the lower electrode 191 in which the auxiliary minute branches 199b are included and the diagonal sides 198a of the center electrode 198 are internally bent.

The first subpixel electrode 191a may receive the data voltage from the first drain electrode 175a through the contact hole 185a, while the second subpixel electrode 191b may receive the data voltage from the first drain electrode 175a through the contact hole 185b.

Next, referring to the upper display panel 200, an upper electrode 270 is disposed on an insulation substrate 210. The upper electrode 270 disposed on each of the subpixels Pxa and Pb may have the same structure as the upper electrode 270 in the previously-described embodiments (e.g., the upper electrode 270 shown in FIG. 3, 9, or 12).

The first electrode 191a and the upper panel electrode 270, along with the liquid crystal layer 3 interposed therebetween, form the first liquid crystal capacitor Clca. The second electrode 191b and the upper panel electrode 270, along with the liquid crystal layer 3 interposed therebetween, form the second liquid crystal capacitor Clcb. The first and second liquid crystal capacitors Clca and Clcb maintain the applied voltage even after the first and second thin film transistors Qa and Qb have been turned off. Moreover, the first and second electrodes 191a and 191b may overlap the storage electrode line 125 to form the first and second storage capacitors Csta and Cstb.

While the inventive concept has been described in connection with what is presently considered to be exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A liquid crystal display comprising:
a lower electrode;
an upper electrode facing the lower electrode; and
a liquid crystal layer disposed between the lower electrode and the upper electrode, the liquid crystal layer including a plurality of liquid crystal molecules aligned substantially perpendicular to surfaces of the lower electrode and the upper electrode,
wherein the lower electrode includes a center electrode disposed at its center and the center electrode has a polygonal shape including diagonal sides, left and right sides, and upper and lower sides, a first cutout disposed at a center of the center electrode, a plurality of minute branches extending out from the diagonal sides, and a plurality of auxiliary minute branches extending out from the left and right sides,
wherein the upper electrode includes a second cutout disposed between the minute branches and the first cutout, and a third cutout connected to the second cutout to form a boundary between a plurality of subregions together with the first cutout, and
wherein the left and right sides are inclined at a predetermined angle.

2. The liquid crystal display of claim 1, wherein the left and right sides are inclined from a vertical side of the lower electrode at an angle ranging from about 10° to about 20°.

3. The liquid crystal display of claim 1, wherein the minute branches extend in different directions at different subregions.

4. The liquid crystal display of claim 1, wherein the auxiliary minute branches extend in different directions at different subregions.

5. The liquid crystal display of claim 1, wherein the first cutout includes a cross-shaped cutout, a central cutout disposed at a center of the cross-shaped cutout, and a central minute cutout extending from the cross-shaped cutout and the central cutout.

6. The liquid crystal display of claim 1, wherein the second cutout includes linear cutouts disposed at the subregions and a vertex disposed on the third cutout.

7. The liquid crystal display of claim 6, wherein the second cutout is disposed surrounding the first cutout.

8. A liquid crystal display comprising:
a lower electrode;
an upper electrode facing the lower electrode; and
a liquid crystal layer disposed between the lower electrode and the upper electrode, the liquid crystal layer including a plurality of liquid crystal molecules aligned substantially perpendicular to surfaces of the lower electrode and the upper electrode,
wherein the lower electrode includes a center electrode disposed at its center and the center electrode has a polygonal shape including diagonal sides, left and right sides, and upper and lower sides, a first cutout disposed at a center of the center electrode, and a plurality of minute branches extending out from the diagonal sides,
wherein the upper electrode includes a second cutout disposed between the minute branches and the first cutout, and a third cutout connected to the second cutout to form a boundary between a plurality of subregions together with the first cutout, and
wherein the diagonal sides are internally bent with respect to a longest minute branch.

9. The liquid crystal display of claim 8, wherein the diagonal sides are bent at points ranging from about ¼ to about ½ of the upper and lower sides from the center of the center electrode to form vertices.

10. The liquid crystal display of claim 8, wherein the minute branches extend in different directions at different subregions.

11. The liquid crystal display of claim 8, wherein the auxiliary minute branches extend in different directions at different subregions.

12. The liquid crystal display of claim 8, wherein the first cutout includes a cross-shaped cutout, a central cutout disposed at a center of the cross-shaped cutout, and a central minute cutout extending from the cross-shaped cutout and the central cutout.

13. The liquid crystal display of claim 8, wherein the second cutout includes linear cutouts disposed at the subregions and a vertex disposed on the third cutout.

14. The liquid crystal display of claim 13, wherein the second cutout is disposed surrounding the first cutout.

15. A liquid crystal display comprising:
a lower electrode;
an upper electrode facing the lower electrode; and
a liquid crystal layer disposed between the lower electrode and the upper electrode, the liquid crystal layer including a plurality of liquid crystal molecules aligned substantially perpendicular to surfaces of the lower electrode and the upper electrode,
wherein the lower electrode includes a center electrode disposed at its center and the center electrode has a polygonal shape including diagonal sides, left and right sides, and upper and lower sides, a first cutout disposed at a center of the center electrode, a plurality of minute branches extending out from the diagonal sides, and as plurality of auxiliary minute branches extending out from the left and right sides,
wherein the upper electrode includes a second cutout disposed between the minute branches and the first cutout, and a third cutout connected to the second cutout to form a boundary between a plurality of subregions together with the first cutout,
wherein the left and right sides are inclined at a predetermined angle, and
wherein the diagonal sides are internally bent with respect to a longest minute branch.

16. The liquid crystal display of claim 15, wherein the left and right sides are inclined from a vertical side of the lower electrode at an angle ranging from about 10° to about 20°.

17. The liquid crystal display of claim 15, wherein the diagonal sides are bent at points ranging from about ¼ to about ½ of the upper and lower sides from the center of the center electrode to form vertices.
